(19) United States
(12) Patent Application Publication
(10) Pub. No.: US 2004/0117667 A1
(43) Pub. Date: Jun. 17, 2004

(54) Synchronization facility for information domains employing replicas

(75) Inventors: Robert Gregory Lavender, Austin, TX (US); Mark Wahl, Austin, TX (US); Duane Baldwin, Woodridge, IL (US); Andrew Coulbeck, Austin, TX (US); Bertold Kolics, Austin, TX (US)

Correspondence Address: ZAGORIN O'BRIEN & GRAHAM, L.L.P., 7600B N. CAPITAL OF TEXAS HWY., SUITE 350, AUSTIN, TX, 78731, US

(73) Assignee: Sun Microsystems, Inc.

(21) Appl. No.: 10/639,294

(22) Filed: Aug. 12, 2003

Related U.S. Application Data
(60) Provisional application No. 60/432,829, filed on Dec. 12, 2002.
(60) Provisional application No. 60/438,386, filed on Jan. 7, 2003.

(51) Int. Cl. H04K 1/00

(52) U.S. Cl. 713/202; 713/182

(57) ABSTRACT

Mechanisms have been developed for synchronizing information, e.g., password or other access credential information, amongst replicated directory spaces or repositories. In some exemplary realizations, directory spaces are embodied as directory servers, services or similar components of computer operating systems, including LDAP, UDDI, Active Directory or other standardized or proprietary directory environments. In one embodiment in accordance with the present invention, a method includes invalidating an entry of at least one replica store. The invalidation of the entry of the replica store triggers information synchronization of a corresponding invalidated entry of a master store to a corresponding entry of an authoritative store on a next attempt to authenticate against the invalidated entry of the replica store. The method may include propagating information of the synchronized master store entry to at least one other replica store.

### CROSS-REFERENCE TO RELATED APPLICATION(S)

This application claims benefit under 35 U.S.C. § 119 of provisional application No. 60/438,386, filed Jan. 7, 2003, entitled “SYNCHRONIZATION FACILITY FOR INFORMATION DOMAINS EMPLOYING DISSIMILAR PROTECTIVE TRANSFORMS” naming Robert Lavender, Mark Wahl, Duane Baldwin, Andrew Coulbeck, and Bertold Kolics as inventors, and, in addition, claims benefit under 35 U.S.C. § 119 of provisional application No. 60/432,829, filed Dec. 12, 2002, naming Robert Lavender, Mark Wahl, Duane Baldwin, Andrew Coulbeck, and Bertold Kolics as inventors.

This application is related to co-pending application number ______, entitled “INVALIDATION FACILITY FOR SYNCHRONIZING INFORMATION DOMAINS” naming Robert Lavender, Mark Wahl, Duane Baldwin, Andrew Coulbeck, and Bertold Kolics as inventors, Attorney Docket No. 004-9364 and co-pending application number ______, entitled “SYNCRONIZATION FACILITY FOR INFORMATION DOMAINS EMPLOYING DISSIMILAR PROTECTIVE TRANSFORMATIONS” naming Robert Lavender, Mark Wahl, Duane Baldwin, Andrew Coulbeck, and Bertold Kolics as inventors Attorney Docket No. 004-9259 filed on even date herewith.

### BACKGROUND

1. Field of the Invention

The present invention relates generally to synchronization amongst information domains that employ replication.

2. Description of the Related Art

Access to information and resources can be controlled through the processes of authentication and authorization. Typically, an entity (e.g., a client and/or user) authenticates by providing information to establish its identity. Once the entity has authenticated, authority (e.g., access rights) is granted to the entity based on the authenticated identity. Information used to verify the identity and privileges of an entity may be stored as entries in a directory system or service. Entries in such systems may be replicated, i.e., multiple versions of the information are created and managed at different locations to increase the reliability of an information store. In addition, replication may improve performance by locating information closer to users and applications that use the information, and by decreasing the number of nodes between a user and the information. Data convergence, i.e., guaranteeing that the multiple versions, i.e., replicas, contain the same data at a given time, is one challenge in replicated systems. This problem is exacerbated in systems that include multiple replicas with authority to update the information store.

Accordingly, techniques are desired whereby information (e.g., user password information) is securely and efficiently updated in a system including one or more replicas of an information store.

### SUMMARY

Mechanisms have been developed for synchronizing information, e.g., password or other access credential information, amongst replicated information stores. In some exemplary realizations, the information stores are embodied as directory servers, services or similar components of computer operating systems, including Lightweight Directory Access Protocol (LDAP), Universal Description, Discovery and Integration (UDDI), Active Directory or other standardized or proprietary directory environments. In some exemplary realizations, replicated information stores are synchronized with directory spaces that employ dissimilar protective transformations, e.g., hashes, encryption, etc. dissimilar protective transformations include differing hashes (or encryption) techniques or facilities employed by products available from Sun Microsystems, Inc., on the one hand, and Microsoft Corporation on another. However, the inventive techniques are not limited thereto.

In one embodiment in accordance with the present invention, a method includes invalidating an entry of at least one replica store. The invalidation of the entry of the replica store triggers information synchronization of a corresponding invalidated entry of a master store to a corresponding entry of an authoritative store on a next attempt to authenticate against the invalidated entry of the replica store. The replica store may be a slave store. The method may include propagating information of the synchronized master store entry to at least one other replica store. The method may include propagating information of the synchronized master store entry to at least a second master store. The method may include invalidating a corresponding entry of at least a second master store. The method may include synchronizing the invalidated entry of the master store to a corresponding entry of an authoritative store. The synchronization of the invalidated entry of the master store to the corresponding entry of an authoritative store may be based at least in part on information received from the replica store. In one realization, the method includes authenticating information at the master store for a request to authenticate at the replica store against the invalidated entry of the replica store. The method may include synchronizing the invalidated entry of the replica store to a corresponding entry of the master store. In one realization, the master store synchronizes the entry of the replica store to the corresponding entry of the master store. The method may include authenticating information at the replica store for a request, received by the replica store, to authenticate at the replica store against a valid entry. The information in the master store and the authoritative store may be encoded using dissimilar protective transforms. The replica store and master store may be encoded using similar or identical protective transforms. In one realization, the method includes detecting change to an entry of an authoritative store. The information may include an encoded credential. The information may include user authentication information. The method may include securing at least some communications between the master and replica stores using a protective transform. The protective transform may be in accordance with a secure sockets layer protocol. In one realization, the method is embodied, at least in part, as a computer program product executable encoded in one or more computer readable media selected from the set of disk, tape, or other magnetic, optical, or electronic storage medium and a network, wireline, wireless, or other communication medium. In one realization, the method may be embodied, at least in part, as a replicated directory system. The replicated directory system may operate in accordance with LDAP.

In another embodiment in accordance with the present invention, a computer system incudes a master store and at least one replica store, wherein the master store pushes invalidation information from the master store to the replica store. In response to the invalidation information, the replica store may chain authentication to the master store. The master store may push synchronization information from the master store to the replica store. The master store may synchronize an invalidated entry with a corresponding entry of an authoritative store in response to an invalidity indicator. In one realization, the computer system includes the authoritative store.

In yet another embodiment in accordance with the present invention, a computer program product executable synchronizes information stored in a replica store with that stored in a master store. The master store synchronizes with an authoritative store in response to an invalidity indication for an entry of the master store and based at least in part on information received from the replica store. The synchronization may be performed without reversing the protective transform employed by the authoritative store. In one realization, the master store updates the replica store.

In still yet another embodiment in accordance with the present invention, a computer program product executable synchronizes information stored in a replica store with that stored in a master store, wherein the replica store authenticates at a master store in response to an invalidity indication for an entry of the replica store. The replica store may chain authentication information to the master store. The master store may synchronize the invalid entry of the replica store. The master store may invalidate at least one entry of the replica store.

In still yet another embodiment in accordance with the present invention, a synchronization facility includes a detector of an invalidated entry of a replica store and an authenticator that chains to a master store authentication requests corresponding to invalidated entries of the replica store. In one realization, the master store synchronizes invalidated entries of the master store with corresponding entries of an authoritative store. In one realization, the master store synchronizes the invalidated entry of the replica store to a corresponding entry of the master store. In one realization, the authenticator authenticates, on the replica store, authentication requests received by the replica store corresponding to valid entries. In one realization, the master store pushes invalidated information to the replica store.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a system for authenticating information in accordance with some embodiments of the present invention.

FIG. 2 depicts information and control flows for an invalidation technique in accordance with some embodiments of the present invention.

FIG. 3 depicts information and control flows for a synchronization technique in accordance with some embodiments of the present invention.

FIG. 4 illustrates an information store employing directory replication in accordance with some embodiments of the present invention.

FIG. 5 depicts information and control flows for a mechanism of replica handling in accordance with some embodiments of the present invention.

FIG. 6 depicts information and control flows for a mechanism of replica handling in accordance with some embodiments of the present invention.

The use of the same reference symbols in different drawings indicates similar or identical items.

### DESCRIPTION OF THE PREFERRED EMBODIMENT(S)

A series of mechanisms have been developed for synchronizing information, e.g., password or other access credential information, amongst directory spaces or repositories, that employ dissimilar protective transformations, e.g., hashes, encryption, etc. In some exemplary realizations, directory spaces are embodied as directory servers, services or similar components of computer operating systems, including Lightweight Directory Access Protocol (LDAP), Universal Description, Discovery and Integration (UDDI), Active Directory or other standardized or proprietary directory environments. In some exemplary realizations, dissimilar protective transformations include differing hash (or encryption) techniques or facilities employed by products available from Sun Microsystems, Inc., on the one hand, and Microsoft Corporation on another. In some exemplary realizations, directory spaces may be replicated. However, the inventive techniques are not limited thereto.

In light of the above, designs presented herein are illustrative and will provide persons of ordinary skill in the art with an understanding of at least some particular exploitations of the inventive techniques and concepts. Based on the description herein, persons of ordinary skill in the art will appreciate that the inventive concepts are not limited to the particular exploitations described. In particular, design goals or constraints peculiar to the exemplary realizations may not affect other realizations or embodiments, and the inventive techniques have important applications to the more general problem of synchronization amongst information domains. Further, particular realizations or embodiments described are not unitary. In particular, all features of a particular realization or embodiment are generally not essential to all exploitations. In addition, based on the description herein, persons of ordinary skill in the art will appreciate various systems, methods, apparati, articles, computer program products, etc. that embody some or all of the techniques and/or concepts presented herein.

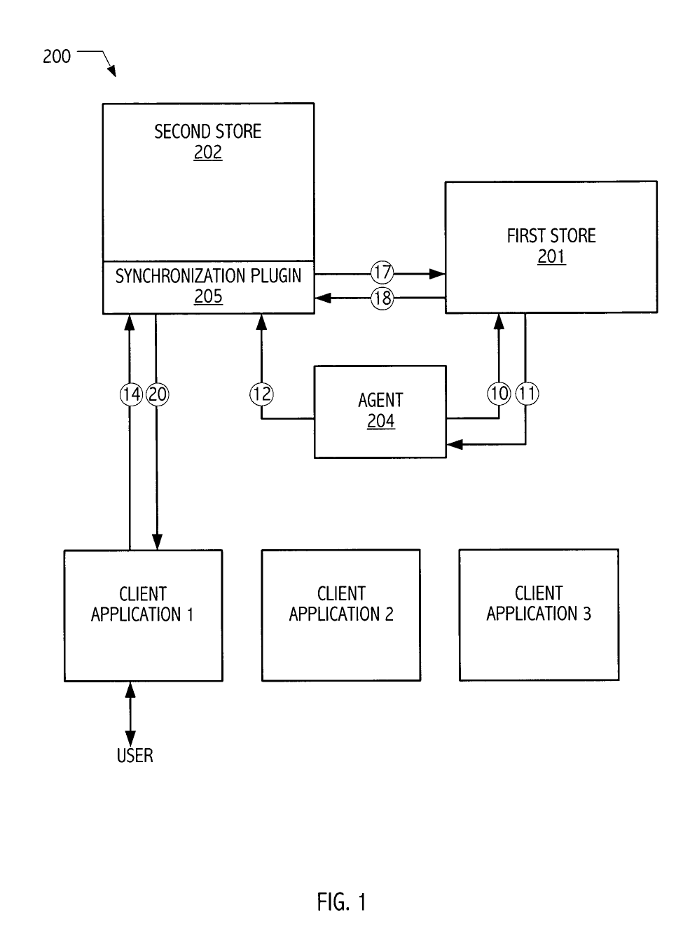

Referring to FIG. 1, exemplary computer system 200 includes first store 201, second store 202, agent 204, synchronization plug-in 205, and client applications 1-3. First store 201 and second store 202 may be embodied as directory services or as authentication or access control services. First store 201 and second store 202 may reside on the same or different computers. First store 201 and second store 202 include data entries, which may include userids, password, credential data, or other information. The data entries of first store 201 and second store 202 are typically encoded using dissimilar protective transforms (e.g., encryption, hash, dissimilar protective transforms with different keys). As will be generally appreciated by persons of ordinary skill in the art, such protective transforms are generally irreversible, i.e., reversal or decryption is computationally infeasible given typical computational facilities and time allowed, without an appropriate key (if any). First store 201 is the authoritative domain for at least some of the entries in second store 202 (i.e., data changes are made at first store 201 and subsequently communicated to second store 202).

Agent 204 and synchronization plug-in 205 are associated with second store 202, i.e., agent 204 invalidates data entries of second store 202 upon detecting changes to corresponding entries in first store 201. Agent 204 may be integrated with first store 201, second store 202, or exist as a separate component in computer system 200. In computer system 200, a plug-in is a software module that customizes or extends the functionality of the directory server. Synchronization plug-in 205 chains an authentication to first store 201. Thus, synchronization plug-in 205 extends the authentication process of computer system 200 because without synchronization plug-in 205, second store 202 would have no knowledge of first store 201. In some realizations, synchronization plug-in 205 is included in second store 202. For example, synchronization plug-in 205 may be installed by including appropriate files in the lib directory under the installation root directory of an iPlanet Directory Server, or similar environment, and by adding configuration information to the directory server via an 1dapmodify command line utility. Agent 204 and synchronization plug-in 205 attain the synchronization of information stored in second store 202 to the entries in first store 201, without reversing the protective transform of first store 201 (e.g., by comparing encoded entries).

Invalidation

In general, invalidation of an entry may be achieved by setting an invalidity, non-authoritative, expiry or other similar indicator appropriate to a given system. In computer system 200, invalidation is achieved by setting an invalidation attribute associated with the entry of second store 202 or by any other method for indicating that an entry to an information store requires synchronization. In a next attempt by a client application to authenticate against the invalidated entry in first store 201, the invalidation triggers synchronization plug-in 205 to synchronize the entry in second store 202 to the information for the corresponding entry in first store 201.

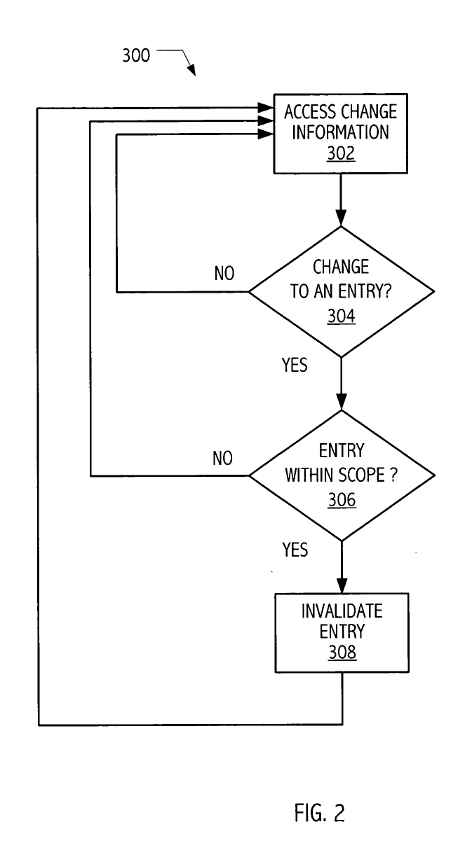

Entries of second store 202 may include an attribute for invalidating the information associated with that entry. Agent 204 may be configured to set this attribute for an entry when agent 204 detects a change to a corresponding entry in first store 201. In some realizations, computer system 200 performs the steps illustrated in FIG. 2. Agent 204 accesses (302) change information associated with the entries in first store 201. Agent 204 may access this change information by sending a request for change information 10 to first store 201 and receiving change information in response. Request for change information 10 may be sent periodically and the frequency of these requests may be programmable. Alternatively, first store 201 or an entity associated therewith, may communicate change information by a preprogrammed periodic communication, thus eliminating the need for request for change information 10. If agent 204 periodically requests update information, agent 204 is configured with a request interval, which may be programmable in some realizations of the invention. For example, the agent may periodically request update information on an hourly, daily, or weekly basis. First store 201 may also acquire change information by intercepting changes and signaling agent 204 of these changes.

Entries of first store 201 and second store 202 may be identified by object guid or distinguished names (DNs). In computer system 200, agent 204 is responsive to a particular DN and password for communication with second store 201. Information stored in first store 201 may be known by a DN different from that used in second store 202. First store 201 maintains a mapping between entries of first store 201 and second store 202. Agent 204 is configured to access a particular attribute of the information entries stored in second store 202. This attribute stores the DN used by first store 201 to reference the entry. A configuration attribute specifies to agent 204 which attribute of entries in second store 202 stores the DN for the first directory service to facilitate mapping from second store 202 to first store 201. During the invalidation procedure, agent 204 may look up entries in second store 202 that correspond to changed entries of first store 201 by sending a request to second store 202 to return an entry having a particular attribute with a particular value. In some realizations, second store 202 may process that query by searching entries of a directory tree for an entry meeting the request critieria. In some realizations, an equality index for an attribute speeds up the invalidation procedure performed by agent 204. In general, an equality index for an attribute includes an entry for values of the attribute in second store 202. When second store 202 processes a query from agent 204, the equality index is referenced to find the entry based on the value of the attribute. Referencing the equality index to find the entry is typically faster than searching a tree of entries in second store 202 for an entry that matches a search criteria.

Referring back to FIG. 1, response 11 provides change information to agent 204. Change information may include information stored in a change log, an update sequence number, or other information indicating a change. A change log is a database that records all changes made to first store 201. As each change is received by first store 201, a unique change number is assigned, and the number is logged to the change log. Agent 204 determines (304) from the change information whether an entry of first store 201 has changed. Referring to FIG. 2, if no change is detected, agent 204 continues to access (302) change information for detecting change to entries of first store 201 by whichever method agent 204 is configured for accessing the information.

If more than one directory exists in a system, each directory or store may include an agent that corresponds to that directory for synchronizing that directory to the authoritative directory or directories. In some realizations, the change scope is a physical or conceptual partition (e.g., database or subtree of entries, a domain in Active Directory, db context in Sun ONE Directory Server) within a repository for which a synchronization component is responsible for synchronizing. The synchronization scope may be a logical grouping of entries (e.g., users) within a change scope. This grouping is used to determine the route of entry change messages on a transport and protocol mechanism used to communicate between components for managing updates between one or more repositories with one or more subcomponents that handle the specialized interaction with the respositories (e.g., the iPlanet Message Queue). In some realizations, upon determining the synchronization scope to which an entry belongs, a synchronization scope identifier may be used as part of a message that will carry the entry change to a managing agent. In some realizations, the synchronization scopes are preferably not nested. Matching synchronization scope for an entry may be determined by searching the synchronization scopes for the components that support a particular partition of a repository. Synchronization of particular entries may be selectively disabled via an attribute used to configure the synchronization agent. If a change is detected (304), agent 204 determines (306) whether the entry is within its change scope. If the changed entry is not within its change scope, agent 204 continues to access (302) change information for detecting changes to entries of first store 201. If the entry is within the change scope of agent 204, agent 204 invalidates the entry (308). Agent 204 sends invalidation instruction 12 to second store 202 to invalidate an entry in second store 202 corresponding to the changed entry of first store 201. In some realizations, synchronization plug-in 205 invalidates an entry by setting the invalidation flag corresponding to the outdated entry in second store 202.

In some file-system based realizations, agent 204 is configured with full paths to directories for accessing log and state files to facilitate interactions with first store 201 and second store 202. Information content associated with first store 201 may be represented in second store 202 using a single one of several servers, although this information may be distributed amongst several servers. Entry location information may be provided by a list of paths to those LDAP URLs for servers that are authoritative for second store 202. Agent 204 is configured with the pathname for second store 202 as included among a list of pathnames for information stores that are synchronized to first store 201. Where the information is stored in domain configuration, a subtree list identifies those trees where information entries of this domain may be found.

In some realizations, the global configuration includes a maximum allowed clock skew between agent 204 and any controller for information stores 201 and 202. The clock skew is irrespective of time zone differences. Agent 204 and controllers for information stores 201 and 202 may operate in different time zones. The maximum allowed clock skew may be adjusted to properly detect and avoid losing information changes.

On-Demand Password Synchronization

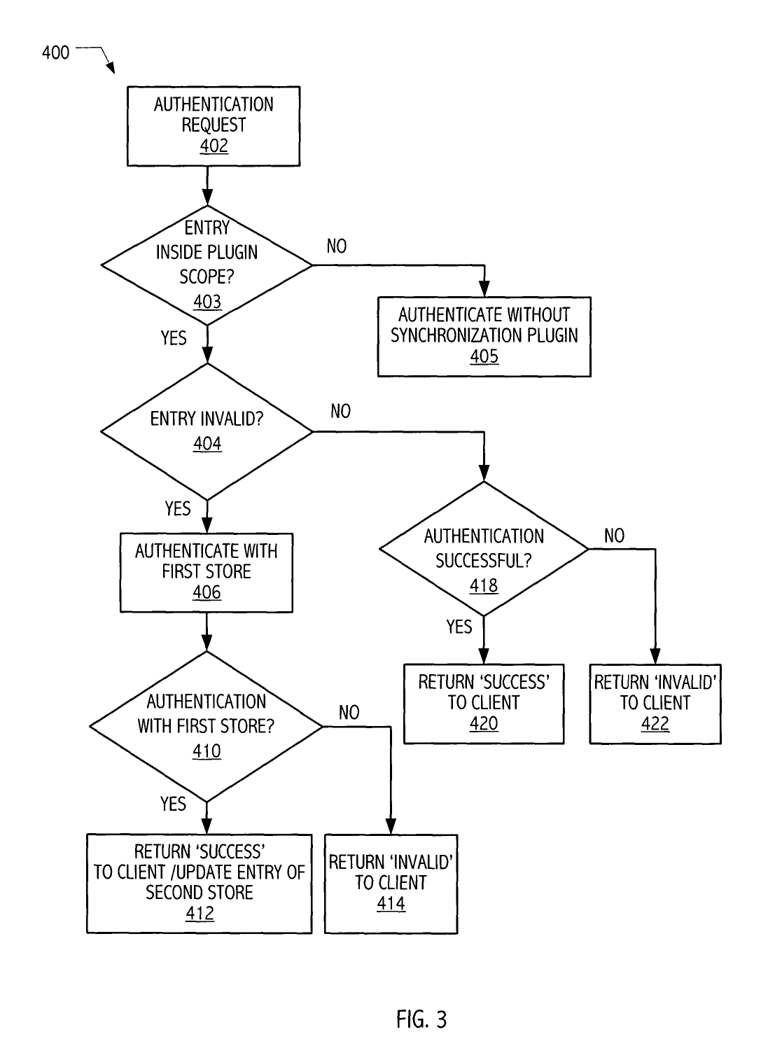

Referring to FIG. 1 and FIG. 3, synchronization plug-in 205 captures password changes and synchronizes entries on-demand. Information entries in first store 201 may be encoded using a suitable protective transform, making the clear text entry from first store 201 unavailable to second store 202 and synchronization plug-in 205. Instead, synchronization plug-in 205 obtains the clear text updated information from a client application when the client attempts to authenticate. Client application 1 attempts to authenticate (402) by sending clear text userid and password information to synchronization plug-in 205 via authentication request 14.

To reduce the risk of compromising security, synchronization plug-in 205 preferably does not write the clear text password values to a log or similar record. In some realizations, synchronization plug-in 204 receives the clear text information, and maintains this information only so long as to reversibly encrypt the information with an encryption utility. The encryption may be performed by using underlying encryption mechanisms of a secure sockets layer (SSL) protocol implementation or other encryption facilities. In the illustrated configuration, synchronization plug-in 205 is configured with a full path to a certificate database although other configurations may access similar information in other ways. The certificate authority that issues the server certificates for first store 201 may be imported, or alternatively, the certificate database may be copied for installation and use by synchronization plug-in 205. When SSL communication is enabled, the LDAP URL for a store that requires SSL encryption includes an SSL indicator in the LDAP URL.

Synchronization plug-in 205 determines (403) whether the user entry is within synchronization scope of synchronization plug-in 205. If the entry is not within the synchronization scope of synchronization plug-in 205, authentication proceeds (405) using any suitable method employed by computer system 200, without synchronization plug-in 205. If the entry is within the synchronization scope of synchronization plug-in 205, synchronization plug-in 205 attempts to authenticate with an entry of second store 202 by authenticating at second store 202. Synchronization plug-in 205 determines (404) whether an entry is invalidated. If the entry is valid, synchronization plug-in 205 then attempts to authenticate (418) the identity information. If the client information authenticates, synchronization plug-in 205 returns ‘success’ (420) to client application 1 in response 20.

If the entry in second store 202 is invalid (404), synchronization plug-in 205 chains the authentication to first store 201, i.e., sends authentication request 17 (406), which in some realizations may be an LDAP bind request, to first store 201. First store 201 sends authentication response 18 to synchronization plug-in 205. Synchronization plug-in determines (410) that the identity information does not authenticate, synchronization plug-in 205 returns ‘invalid’ (414) to client application 1 in response 20. Alternatively, if synchronization plug-in 205 determines (410) that the identity is valid based on authentication response 18, synchronization plug-in 205 synchronizes the entry of second store 202 (412). Synchronization plug-in 205 updates the entry of second store 202 with the information received in clear text from client application 1. Updates may be made by changing the entry or by replacing the entry with a valid instance of the entry. In some realizations, the information is encrypted using a protective transform dissimilar to the protective transform utilized by first store 201. In addition, synchronization plug-in 205 clears the invalidation attribute for the user entry and, synchronization plug-in 205 returns ‘success’ to client application 1.

Synchronization plug-in 205 logs information, warnings, and error messages according to the log level setting of a host directory server. In addition to the log facility provided by the directory server, synchronization plug-in 205 may send log messages about server errors to the directory system manager. Typically, synchronization plug-in 205 is also configured with the name of the attribute in the second store that holds the domain name for the first directory service. The name of the attribute that is used for invalidation by agent 204 is also identified to synchronization plug-in 205. Synchronization plug-in 205 checks this attribute upon each authentication. When the attribute is set, synchronization plug-in 205 will force password verification against an authoritative domain (e.g., domain controller) in the first directory service. If more than one domain controller serves the same domain, synchronization plug-in 205 is provided with a list of LDAP URLs for each of these domain controllers. In some realizations, the LDAP URL for a store that requires SSL encryption is indicated by an indicator in the LDAP URL.

Replica Handling

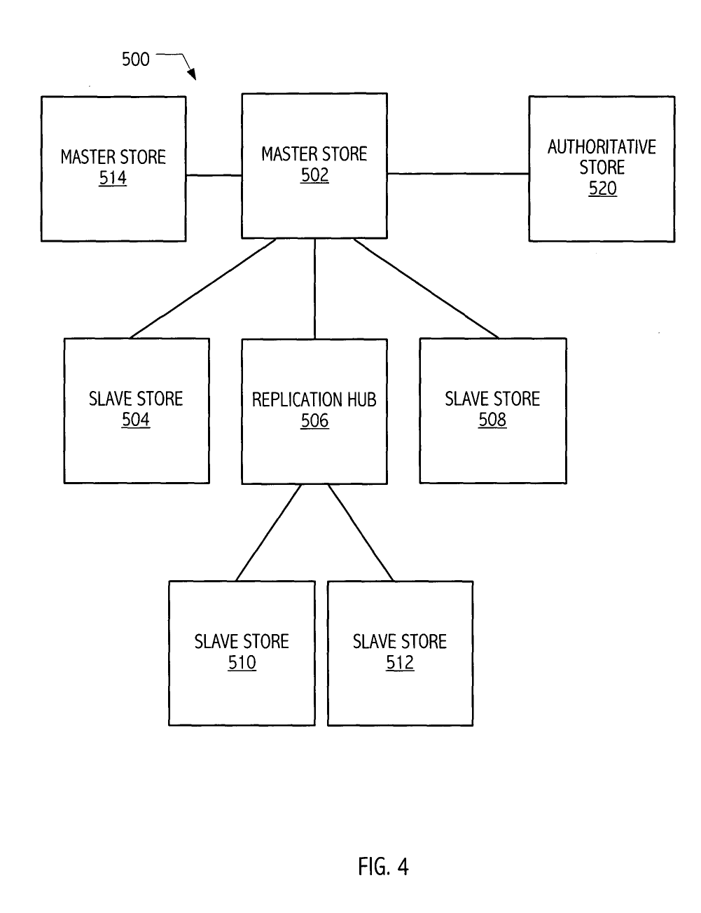

Referring to FIG. 4, an exemplary replicated computer system includes authoritative store 520 and replicas 502-14, which are configured as master store 502, master store 514, slave stores 504, 508-512, and replication hub 506. In general, replica stores 502-514 and authoritative store 520 may be embodied as, or in, application servers (e.g., programs, computers, and/or systems of computers that manage resources), directory services, authentication or access control services, or other similar servers or services. Replicas 502-514 and authoritative store 520 may reside on the same or different computers. A particular one of replicas 502-514 may reside on a single computer or be distributed across a plurality of computers. The unit of replication, i.e., the set of entries to be replicated, may be a database or a subtree of a database or any other grouping of entries consistent with a replication protocol. Replicas 502-514 and authoritative store 520 include data entries, which may include user ids, passwords, credential data, or other information. Data entries, or some fields of data entries of authoritative store 520 may be encoded using a protective transform that is dissimilar to the protective transform, if any, used by replicas 502-514. Authoritative store 520 updates entries based on information changes that are subsequently communicated to replicas 502-514.

A master store is typically a writeable replica that updates entries and propagates updates to slave stores using a replication protocol. Master stores may maintain a change log that records modifications that have occurred in the master store. The change log may include a record describing an operation, e.g., an LDAP operation, that was performed to modify an entry. The change log may be accessible to other stores via a protocol such as LDAP, or it may be intended for internal use only and accessible by a plug-in that facilitates accesses. A replication hub typically maintains a read-only copy of replicated information. A replication hub typically receives updates from a master store and communicates changes to other read-only replicas or replications hubs. In some replication protocols, a replication hub maintains a change log. In general, a replica may accept changes for some entries, i.e., a replica may be a master with respect to some entries, while the replica may be read-only with respect to other entries, behaving as a slave store with respect to those read-only entries. For example, in multi-master replication, more than one replica may be concurrently configured as a master store for particular entries. A master store may accept changes, but also receive changes from other master stores. Accordingly, as used herein, the term replica encompasses stores or facilities that mediate replicated information (whether a master, slave, etc.) and the description and claims will be understood in that light.

Although FIG. 4 designates replica 502 as a master store, this designation is for illustration purposes only and a designation as a master store, replication hub, or slave store is not intended to be limiting. Replica stores may be configured and reconfigured as master stores, slave stores, or replication hubs according to a replication protocol. Replicas may be master stores, slave stores, and/or replication hubs with respect to particular entries. The relationship between two replicas may be specified in a replication agreement that defines the replication configuration. This agreement may be configured on the master store. In a multi-master replication configuration, a replication agreement may reside on each master store. A typical replication agreement may specify, but is not limited to, a database to be replicated, a replica store to which data is pushed, times during which replication may occur, credentials the master store supplies to bind to the replica store, and the method of securing a connection (e.g., SSL, client authentication).

In some replication protocols, replication may be initiated by a master store, allowing a single master store to push data to multiple slave stores. In some replication protocols, slave stores may be configured to pull data from a master store. In some replication protocols, a slave store may initiate replication by prompting a master store to communicate updates. The scheduling of these updates affects the consistency of corresponding entries of replica stores. Replica stores may be synchronized or strongly consistent, i.e., a replica provides the same information as a master store. Replicas may be weakly or loosely consistent, i.e., a replica may supply information that diverges from a master store and updates may be scheduled within a reasonable time.

In multi-master replication configurations, corresponding entries may be changed in different master stores. In some replication protocols, when replication occurs between the two stores, conflicting changes are resolved based on a timestamp associated with the change in each store, the most recent change taking precedence. In some replication protocols, orphan entry conflicts (i.e., an entry to be deleted that has child entries) may be detected by the slave store. These orphan entry conflicts may be resolved by inserting a temporary glue entry representing the parent. In some situations, a conflict may not be resolved automatically based on the timestamp, but may be resolved by manual intervention. To indicate a need for manual intervention, a replication protocol may include a conflict marker attribute, which, when set, may facilitate searching for entries requiring manual conflict resolution.

Referring back to FIG. 4, master store 502 accepts changes and communicates them to replicas 504-514. The information in master store 502 and replicas 504-514 may be encoded using similar or identical protective transforms. Communications between master store 502 and replicas 504-514 may be secured using a protective transform (e.g., SSL protocol). In some replication protocols, replicas 504-514 may authenticate master store 502 when master store 502 sends replication updates. Replica stores 502-514 may include entries for authenticating each master store (e.g., master store 502 or master store 514, as the case may be) from which replicas 502-514 obtain updates. These entries are typically not part of the replicated data, for security purposes and may have a special user profile that bypasses access control rules on the replica store.

In the configuration illustrated, each one of replicas 502-514 includes an instantiation of a synchronization plug-in, such as described above, to facilitate client authentication at a replica information store in a system. At startup, each instance of the synchronization plug-in registers itself as a pre-operation modify plug-in, so that modify requests will be passed to this plug-in before execution. Although the synchronization plug-in is installed on each of the illustrated replicas, the synchronization plug-in is configured to capture passwords on master stores 502 and 514 only. Of course other realizations may instantiate differing plug-ins, selectively instantiate, or use similar techniques to achieve similar variation in function.

Similarly, the synchronization plug-in is configured to identify whether the local database is updateable locally. For example, entries of slave stores are generally not updateable locally. In this situation, the synchronization plug-in is informed of which servers in the directory service are masters for the slave store. The synchronization plug-in forwards the authentication to the master store and lets the instantiation of the plug-in corresponding to the master store verify the identity of the user and update information entries, if necessary. Once the entries of a master store are updated, the information of read-only and replication hubs is updated by a master store consistent with any suitable replication protocol implemented by the system. While any of a variety of replication protocols may be used or adapted for use in the transport(s) of information described herein, replication facilities such as those used by (and documented for) the iPlanet™ Directory Server. See generally, Sun Microsystems, Inc., iPlanet Directory Server 5.1 Deployment Guide (2001), chs. 6 and 8, available at http://docs.sun.com/source/816-5609-10. iPlanet is a trademark of Sun Microsystems, Inc. in the U.S. and in other countries.

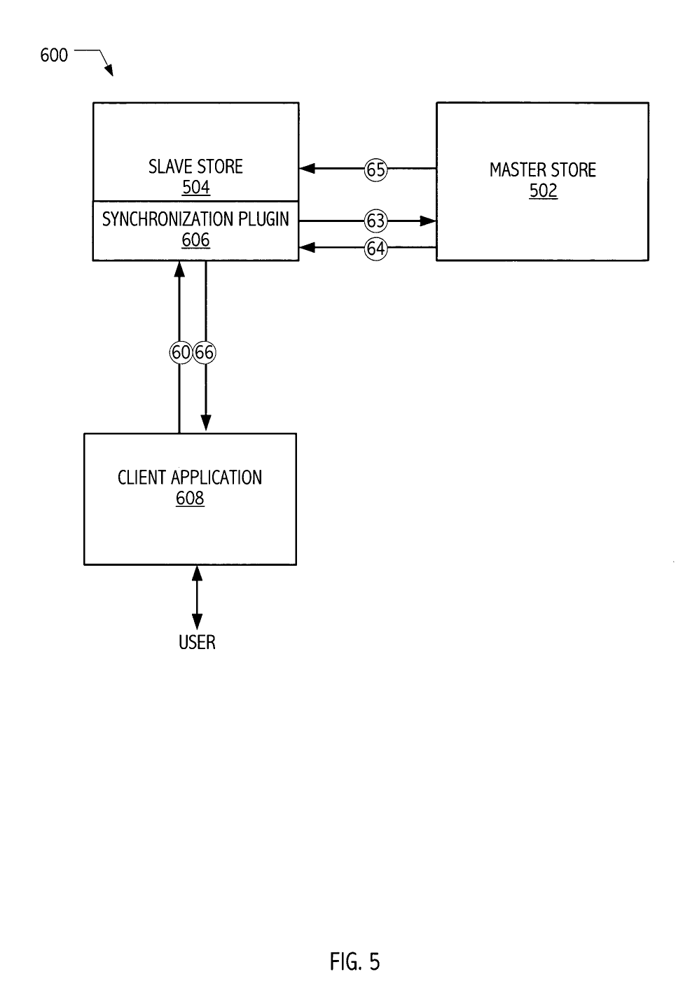

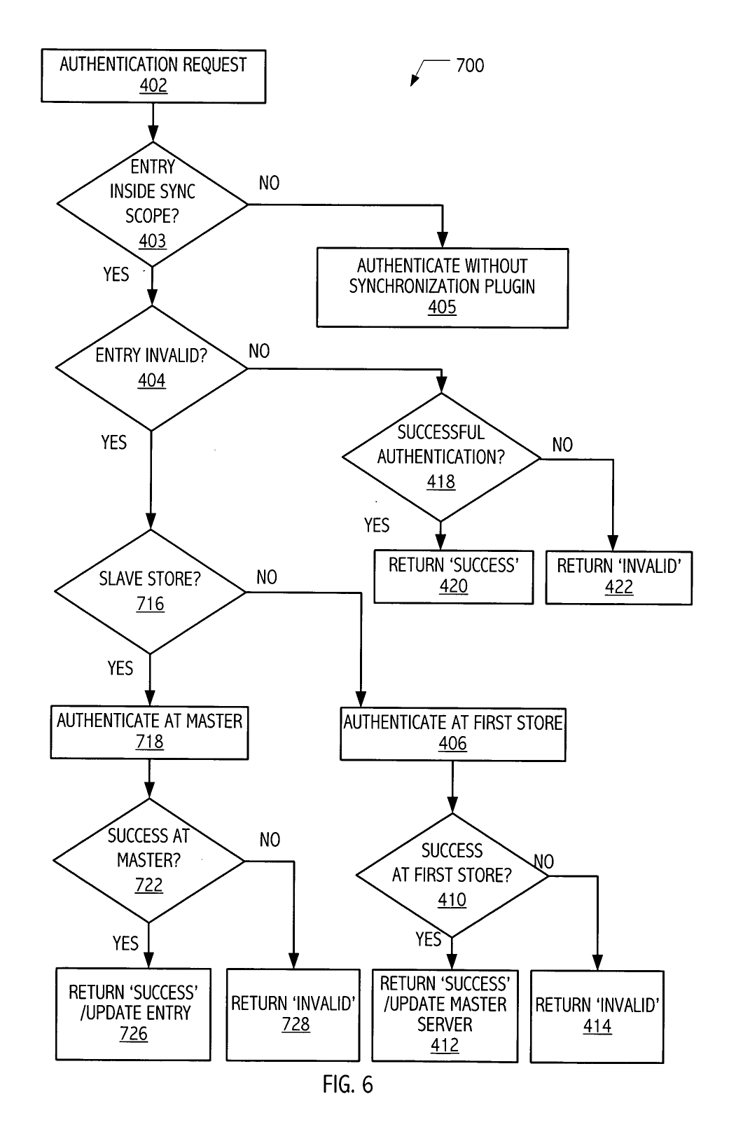

The operation of the synchronization plug-in in a replicated system is illustrated in FIG. 6, which is an adaptation of FIG. 3 including facilities for replica handling. FIGS. 5 and 6 describe the case of a slave store. An instantiation of the synchronization plug-in, synchronization plug-in 606, corresponds to slave store 504 and is called when client application 608 attempts to gain access to slave store 504. Entries in slave store 504 can be updated only by a master store (e.g., master store 502) via the system replication protocol.

Synchronization plug-in 606 receives (402) authentication request 60, initiated by client application 608. If the entry is not within the synchronization scope of synchronization plug-in 606 (403), synchronization plug-in 606 ceases the authentication process and authentication proceeds (405) without synchronization plug-in 606. If the entry is within the synchronization scope of synchronization plug-in 606, authentication proceeds by determining whether the entry is invalid (404).

If the applicable entry is valid, synchronization plug-in 606 then determines (418) if the information authenticates with the entry stored in slave store 504. If the information authenticates, synchronization plug-in 606 returns ‘success’ (420) to client application 608, via response 66. If the information fails to authenticate, synchronization plug-in 606 returns ‘invalid’ to client application 608, via response 66 (422). If the entry is invalid (404), synchronization plug-in 606 determines (716) that the information store is read-only and proceeds to authenticate (718) at master store 502. To facilitate authentication at master store 502 the information is encoded using any suitable protective transform and the encoded information is communicated to master store 502. Upon successful transformation of the clear text information into a protective encoded form, the clear text information is deleted.

If the information authenticates (722) with an entry of master store 502, then synchronization plug-in 606 returns a ‘success’ indication (726) to client application 608 in response 66. However, unlike in a master store, the synchronization plug-in associated with a read-only replica does not update the invalid entry. Instead, the master store updates the entry via a replication procedure. In FIG. 5, master store 502 updates an entry of slave store 504 by way of communication 65, which is compliant with the replication protocol of computer system 600. If authentication at master store 502 is unsuccessful (722) then synchronization plug-in 606 returns an ‘invalid’ indication (728) to client application 608.

The analysis prior to 716 and following a determination by 716 that the node is a master store is similar to the previous discussion of FIG. 1 and FIG. 3. In this case, 412 may also include updating any replicas via a replication procedure.

Referring to FIG. 4, master store 502 corresponds to second store 202 of FIG. 1 and is synchronized to authoritative store 520, which corresponds to first store 201 in FIG. 1. At least one entry of master store 502 is updated with changes to a corresponding entry of authoritative store 520, consistent with FIGS. 1-3, and the corresponding description. An agent, e.g., agent 204, may detect changes to authoritative store 520 and invalidate a corresponding entry of master store 502. The invalidation is also pushed to replicas 504-514. Upon an update to an entry of master store 502, e.g. in 412 of FIG. 3, master store 502 may push changes to read-only replicas 504-512.

In a multi-master replication configuration, the synchronization plug-ins corresponding to replicas 504-512 may failover to master store 514 if master store 502 becomes unavailable. Upon a change to an entry of a master store 502 (including changes to invalidation attributes), master store 502 pushes the change to master store 514, in addition to pushing the changes to read-only replicas 504-512. In one realization, replicas 502-514 apply changes in order. Entries of replicas 502-514 may be weakly-consistent with each other, i.e., an entry of replicas 504-512 may diverge from a corresponding entry of master store 502 or master store 514 while the entry of replicas 504-512 are invalidated and the corresponding entry of master store 502 or master store 514 is not invalidated. However, the entries of replicas 504-512 eventually converge to the entries of master store 502 and master store 514.

While the invention(s) is(are) described with reference to various implementations and exploitations, and in particular with respect to synchronization of user access credentials, it will be understood that these embodiments are illustrative and that the scope of the invention(s) is not limited to them. Terms such as always, never, all, none, etc. are generally used herein to describe invariants, consistent states or compatibility requirements presented by a given computational system or implementation environment. Accordingly, persons of ordinary skill in the art will recognize that certain transitory states may and do exist in physical implementations even if not presented by the computational system. Similarly, persons of ordinary skill in the art will recognize that other consistent state or compatibility requirements may and will be presented as techniques of the present invention(s) are exploited in other computational system or implementation environments. Such terms and invariants will be understood in light of the above, rather than as essential design requirements for all realizations or embodiments of the inventive concepts.

Many variations, modifications, additions, and improvements are possible. For example, while application to particular password synchronization challenges and particular directory service domains have been described in detail herein, applications to other credentials, indeed other information entirely, as well as other directory service or information repositories will be appreciated by persons of ordinary skill in the art. In addition, varying replication protocols may be employed and a variety of suitable change detection, propagation and/or notation techniques may be used. Other appropriate transformations, including one-way, two-way, reversible or irreversible transformations, hashes and encryption, including public and/or private-key variations, may be employed in some realizations. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the claims that follow.

What is claimed is:

1. A method for synchronizing entries in a replicated storage system, the method comprising:
invalidating an entry of at least one replica store,
wherein the invalidating of the entry of the replica store triggers information synchronization of a corresponding invalidated entry of a master store to a corresponding entry of an authoritative store on a next attempt to authenticate against the invalidated entry of the replica store.

2. The method, as recited in claim 1, wherein the replica store is a slave store.

3. The method, as recited in claim 1, further comprising:
propagating information of the synchronized master store entry to at least one other replica store.

4. The method, as recited in claim 1, further comprising:
propagating information of the synchronized master store entry to at least a second master store.

5. The method, as recited in claim 1, further comprising:
invalidating a corresponding entry of at least a second master store.

6. The method, as recited in claim 1, further comprising:
synchronizing the invalidated entry of the master store to a corresponding entry of an authoritative store.

7. The method, as recited in claim 6, wherein the synchronization of the invalidated entry of the master store to the corresponding entry of an authoritative store is based at least in part on information received from the replica store.

8. The method, as recited in claim 1, further comprising:
authenticating information at the master store for a request to authenticate at the replica store against the invalidated entry of the replica store.

9. The method, as recited in claim 1, further comprising:
synchronizing the invalidated entry of the replica store to a corresponding entry of the master store.

10. The method, as recited in claim 9, wherein the master store synchronizes the entry of the replica store to the corresponding entry of the master store.

11. The method, as recited in claim, 1 further comprising:
authenticating information at the replica store for a request, received by the replica store, to authenticate at the replica store against a valid entry.

12. The method, as recited in claim 6, wherein the information in the master store and the authoritative store are encoded using dissimilar protective transforms.

13. The method, as recited in claim 1, wherein the replica store and master store are encoded using similar or identical protective transforms.

14. The method, as recited in claim 1, further comprising:
detecting change to an entry of an authoritative store.

15. The method, as recited in claim 1, wherein the information includes an encoded credential.

16. The method, as recited in claim 1, wherein the information includes user authentication information.

17. The method, as recited in claim 1, further comprising:
securing at least some communications between the master and replica stores using a protective transform.

18. The method, as recited in claim 17, wherein the protective transform is in accordance with a secure sockets layer (SSL) protocol.

19. The method, as recited in claim 1, embodied, at least in part, as a computer program product executable encoded in one or more computer readable media selected from the set of disk, tape, or other magnetic, optical, or electronic storage medium and a network, wireline, wireless, or other communication medium.

20. The method, as recited in claim 1, embodied, at least in part, as a replicated directory system.

21. The method, as recited in claim 20, wherein the replicated directory system operates in accordance with a Lightweight Directory Access Protocol (LDAP).

22. A computer system comprising:
a master store; and
at least one replica store, wherein the master store pushes invalidation information from the master store to the replica store.

23. The computer system of claim 22, wherein in response to the invalidation information, the replica store chains authentication to the master store.

24. The computer system of claim 22, wherein the master store pushes synchronization information from the master store to the replica store.

25. The computer system of claim 22, wherein the master store synchronizes an invalidated entry with a corresponding entry of an authoritative store in response to an invalidity indicator.

26. The computer system of claim 25 further comprising:
the authoritative store.

27. A computer program product executable to synchronize information stored in a replica store with that stored in a master store, wherein the master store synchronizes with an authoritative store in response to an invalidity indication for an entry of the master store and based at least in part on information received from the replica store.

28. The computer program product executable of claim 27,
wherein the synchronization is performed without reversing the protective transform employed by the authoritative store.

29. The computer program product executable of claim 27, wherein the master store updates the replica store.

30. A computer program product executable to synchronize information stored in a replica store with that stored in a master store, wherein the replica store authenticates at a master store in response to an invalidity indication for an entry of the replica store.

31. The computer program product executable of claim 30, wherein the replica store chains authentication information to the master store.

32. The computer program product executable of claim 30, wherein the master store synchronizes the invalid entry of the replica store.

33. The computer program product executable of claim 30, wherein the master store invalidates at least one entry of the replica store.

34. The computer program product executable of claim 30, wherein the master store invalidates at least one entry of a second master store.

35. A synchronization facility comprising:
a detector of an invalidated entry of a replica store; and
an authenticator that chains to a master store authentication requests corresponding to invalidated entries of the replica store.

36. The synchronization facility of claim 35, wherein the master store synchronizes invalidated entries of the master store with corresponding entries of an authoritative store.

37. The synchronization facility of claim 35, wherein the master store synchronizes the invalidated entry of the replica store to a corresponding entry of the master store.

38. The synchronization facility of claim 35, wherein the authenticator authenticates, on the replica store, authentication requests received by the replica store corresponding to valid entries.

39. The synchronization facility of claim 35, wherein the master store pushes invalidated information to the replica store.

40. An apparatus comprising:
a replica store;
means for synchronizing an invalidated entry of a replica store to an entry of an authoritative store that employs a different protective transform than the replica store.

41. The apparatus of claim 40 further comprising:
means for invalidating an entry of the replica store corresponding to a changed entry in the authoritative store.
